(19) United States
(12) Patent Application Publication
(10) Pub. No.: US 2006/0272514 A1
(43) Pub. Date: Dec. 7, 2006

(54) Cooking apparatus and related method

(76) Inventor: Michael T. Curtis, Denham Springs, LA (US)

Correspondence Address: SIEBERTH & PATTY, LLC, 4703 BLUEBONNET BLVD, BATON ROUGE, LA, 70809, US

(21) Appl. No.: 11/403,478

(22) Filed: Apr. 13, 2006

Related U.S. Application Data
(60) Provisional application No. 60/688,058, filed on Jun. 7, 2005.

(51) Int. Cl. A47J 37/12

(52) U.S. Cl. 99/403

(57) ABSTRACT

This invention provides a pot for frying or boiling, which comprises a pot having at least one side wall. The side wall defines an opening at a level proximate to a top portion of the side wall, and a conduit sealably connected to the opening and extending outward from the side wall. The conduit has a first end defined by the opening and a second end defining an outlet. An interior volume defined by the pot is in fluid communication with the conduit. An apparatus capable of sealably attaching to a pot for frying or boiling is also disclosed.

### REFERENCE TO RELATED APPLICATION

A claim is hereby made to the benefits of the priority of co-pending and co-owned U.S. Provisional Patent Appl. No. 60/688,058 filed on Jun. 7, 2005, the disclosure of which is incorporated herein by reference.

### TECHNICAL FIELD

This invention relates to a safety device for a cooking apparatus.

### BACKGROUND

In a large frying pot, a consumer typically uses approximately 3 to 5 gallons of oil for frying various items, the amount of oil used depending on the specific weight of the item being fried. The oil is typically heated by a heat source located directly under the pot. This oil is often heated to temperatures in excess of 300 degrees Fahrenheit. Frequently, the item to be deep-fried contains a certain amount of water. For example, a turkey retains some amount of water in the cavity, under the skin, and sometimes is damp on the outside due to washing of the bird. Thus, when the turkey (or other item) is lowered into the hot oil, a reaction to the water takes place, usually resulting in the grease spattering and overflowing the pot to contact the frying pot's heat source, resulting in a conflagration.

It would be desirable to have frying pots and similar cooking apparatus that minimize or prevent the risk of fire associated with the overflow of hot oil from such cooking apparatus.

### SUMMARY OF THE INVENTION

The present invention significantly reduces the risk of overflow and thus the risk of a grease fire. The invention provides a mechanism for safe overflow of the hot oil so that the oil does not contact the cooking apparatus' heat source, thus minimizing the possibility of a fire. This invention is also useful for boiling pots, because an overflow of boiling water can injure people in close proximity to the pot when this occurs.

One embodiment of this invention is a pot for frying or boiling, which comprises a pot having at least one side wall, the side wall defining an opening at a level proximate to a top portion of the side wall, and a conduit sealably connected to the opening and extending outward, and preferably substantially horizontally outward, from the side wall of the pot. The conduit has a first end defined by the opening and a second end defining an outlet, the outlet preferably being capable of sealably attaching to a hose. An interior volume defined by the pot is in fluid communication with the conduit.

Another embodiment of this invention is an apparatus which comprises a nut capable of sealably attaching to a side opening which is defined by a side wall of a pot for frying or boiling, which opening is preferably at a level proximate to a top portion of the sidewall, and a conduit. The conduit has a first end for attachment to the nut and a second end defining an outlet, the outlet preferably being capable of sealably attaching to a hose. The apparatus is such that a volume defined by the pot is capable of being in fluid communication with the nut and the conduit, and such that the conduit extends substantially horizontally outward from the wall of the pot.

Still another embodiment of this invention is a method for frying a food item. The method comprises (a) providing a frying pot, a side wall of which defines a side opening at a level proximate to a top portion of the side wall, (b) connecting a conduit having a first end capable of sealably attaching to the frying pot and a second end defining an outlet to the side wall of the frying pot so as to place the conduit in fluid communication with an interior volume of the pot, (c) placing a cooking oil into the interior volume of the frying pot, (d) applying heat to the frying pot, (e) placing the food item into the frying pot under conditions sufficient to cause the food item to fry, and (f) draining through the side opening and conduit at least a portion of the cooking oil which rises to the level of the side opening after the food item is placed into the pot under conditions sufficient to cause the food item to fry.

Yet another embodiment of this invention is a kit for adaptation of a frying pot for safer use. The kit comprises (i) a nut for attachment to an opening which is defined by a side wall of a pot for frying or boiling, (ii) a conduit having a first end capable of sealably attaching to the nut and a second end defining an outlet, and (iii) optionally a hose.

### BRIEF DESCRIPTION OF THE DRAWINGS

FIG. 1 is an external side view of a frying pot with a conduit and a hose attached to the conduit.

FIG. 2 is an external side view of an unassembled apparatus of the invention and a flying pot.

FIG. 3 is an external side view of an assembled apparatus of the invention attached to a frying pot.

FIG. 4 is a top view of a frying pot to which an apparatus of the invention has been attached.

These and other features of this invention will be still further apparent from the ensuing description, drawings, and appended claims.

### FURTHER DETAILED DESCRIPTION OF THE INVENTION

Throughout this document, the terms “oil” and “grease” are used interchangeably.

The frying or boiling pot generally has a high wall, and often a capacity of 3 or more gallons, though the invention is equally useful in smaller-volume pots having a high wall. When the pot is cylindrical, which is the usual case, there is only one wall. By “high wall” it is meant that the wall(s) of the pot are at least about as high as the width of the base of the pot.

The side opening defined by the side wall of the frying or boiling pot is at a level proximate to a top portion of the sidewall of the pot. The opening should be below the top of the wall of the pot to prevent overflow of the grease (or water), while being at a height that allows enough oil (or water) to remain in the pot to cook the food. The optimum location for the side opening will vary with the size of the pot.

The conduit of the frying or boiling pot is sealably attached to the side opening of the frying or boiling pot, and preferably is oriented substantially horizontally. The term “substantially horizontally” allows for deviations from the horizontal. Orientations of the conduit that are above horizontal (relative to the ground) do not allow for quick drainage, and would not provide the benefits of the present invention. Orientations of the conduit that are too far below the horizontal (relative to the ground) may allow the hot oil to drain too close to the heat source for the frying pot, and thus fail to prevent a fire. Preferred orientations for the conduit are an angle of about 45 degrees to about 90 degrees from the vertical (starting at the ground); more preferred are nearly horizontal and horizontal orientations.

The optional hose to be attached to the conduit may be of any material that will not be compromised by the hot oil (or water) flowing through it. Here, the term “compromised” includes softening as well as melting, because, over time, softening can lead to damage and/or rupture of the hose, allowing grease to leak out of the hose, possibly onto the heat source, and cause a fire. Preferably, the end of the hose to be attached to the second end of the conduit, as well as the second end of the conduit, are threaded so that they may be securely attached to each other. Other methods than threading may be used, provided that such methods securely attach the hose and second end of the conduit, and provide a good seal so that the hot oil does not leak out at the point of attachment.

The volume of the frying or boiling pot is in fluid communication with the conduit, so that overflowing hot oil or water may drain out of the pot via the conduit. When a hose is attached, it is in fluid communication with the conduit to further carry the draining hot oil or water away from the frying or boiling pot.

In the apparatus of the invention, the nut is normally and preferably threaded; a threaded nut is especially preferred when the side opening defined by the side wall of the pot is threaded. The nut is on the interior of the side wall, and the conduit extends through the side wall to attach to the nut. Because the conduit usually attaches to the nut in an orientation parallel to the nut, the orientation of the conduit relative to the ground is often determined by the orientation of the nut. The conduit in the apparatus of the invention, once sealably attached, is preferably such that it extends substantially horizontally outward from the wall of the pot; the meaning of “substantially horizontally” is as described above. The nut and conduit are in fluid communication; once attached to the pot, the nut will be in fluid communication with an interior volume defined by the pot. As mentioned above, a hose can be sealably attached to the outlet of the conduit so that hot oil or water may be drained further away from the frying or boiling pot and its heat source.

In preferred embodiments for the apparatus of the invention, the nut and the conduit are one piece. Another preferred apparatus of the invention has two nuts, one (the first nut) on the interior side of the side wall, and the other (the second nut) on the exterior of the side wall. Here, the first nut and the conduit may be one piece.

It should now be appreciated that this invention provides apparatus which may be used to adapt or retrofit an existing frying pot to prevent oil overflow. The apparatus described in the preceding paragraph could be sold as a kit (without the pot) for installation on such a pot. A kit according to this invention for adaptation of a frying pot for safer use comprises (i) a nut for attachment to an opening which is defined by a side wall of a pot for frying or boiling, (ii) a conduit having a first end capable of sealably attaching to the nut and a second end defining an outlet, and (iii) optionally a hose. The conduit and the nut can be one piece. When a hose is present in the kit, the hose preferably has an end which is threaded, and the second end of the conduit is also preferably threaded.

In an operation using the frying or boiling pot of the invention or a frying or boiling pot to which the apparatus of the invention has been attached, the hot oil or water, when it reaches the level at which the conduit is located, flows out through the conduit and attached hose into an appropriate receptacle.

A method for frying a food item according to this invention comprises (a) providing a frying pot, a side wall of which defines a side opening at a level proximate to a top portion of the side wall, (b) connecting a conduit having a first end capable of sealably attaching to the frying pot and a second end defining an outlet to the side wall of the frying pot so as to place the conduit in fluid communication with an interior volume of the pot, (c) placing a cooking oil into the interior volume of the frying pot, (d) applying heat to the frying pot, (e) placing the food item into the frying pot under conditions sufficient to cause the food item to fry, and (f) draining through the side opening and conduit at least a portion of the cooking oil which rises to the level of the side opening after the food item is placed into the pot under conditions sufficient to cause the food item to fry.

In preferred methods of the invention, a hose is sealably attached to the outlet of the conduit, where the hose is in fluid communication with the conduit. It is also preferred that the conduit is connected to the side wall of the frying pot via a nut. Preferably, the conduit and the nut are one piece.

The Figures represent preferred embodiments, and are not intended to be construed as limiting the invention.

Referring now to the Figures, FIG. 1 is an external side view of a frying pot 10 with a side wall 12 having a conduit 16, which has a first end 18 and a second end 20. A hose 22 is attached to the conduit 16. The second end of the conduit 20 and the end of the hose 24 are threaded.

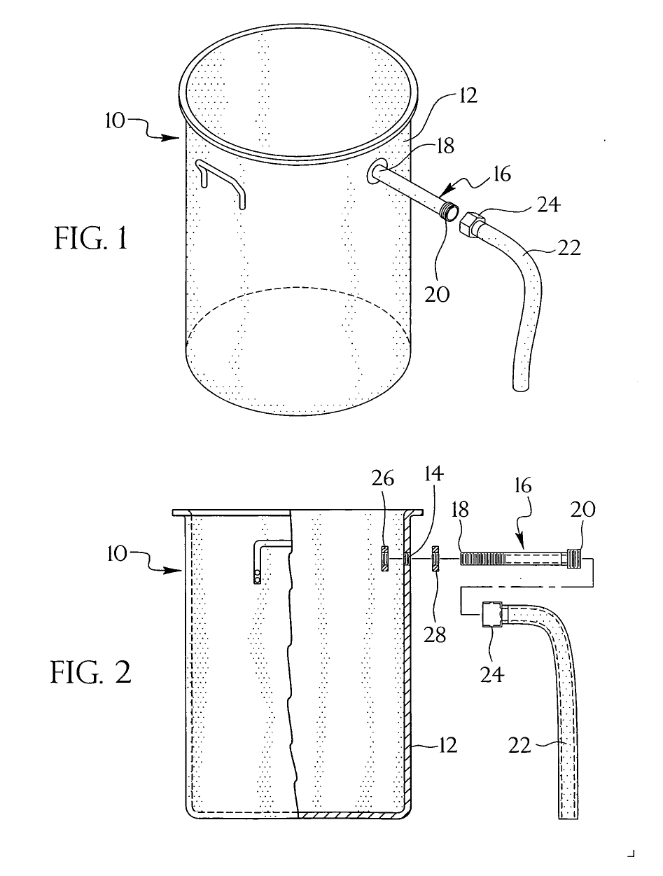

FIG. 2 is an external side view of an unassembled apparatus of the invention and a frying pot 10. The opening 14 in the side wall 12 is threaded. The conduit 16 is threaded at both the first end 18 and the second end 20. Shown are nuts 26 and 28. The first nut 26 will be on the interior of the side wall, and the second nut 28 will be on the exterior of the side wall. The first end of the conduit 18 will extend into the pot so that the first nut 26 (on the interior of the side wall 12) attaches to the conduit 16. The hose 22 is threaded at its end 24 to attach to the second end of the conduit 20.

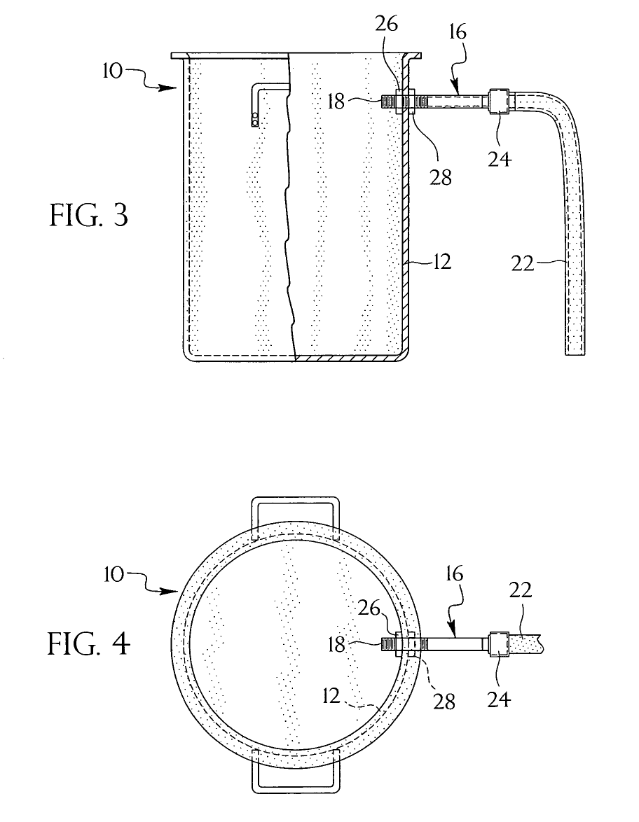

FIG. 3 is an external side view of an assembled apparatus of the invention attached to a frying pot 10. The first end 18 of the conduit 16 extends through the side wall 12, and the first nut 26 is attached to the conduit 16 on the interior of the side wall 12. The second nut 28 is attached to the conduit 16 on the exterior of the side wall 12. The second end 20 of the conduit 16 is covered by the end 24 of the hose 22. A variation on this is a conduit where the second end of the conduit covers the end of the hose.

FIG. 4 is a top view of a frying pot 10 to which an apparatus of the invention has been attached. The first end 18 of the conduit 16 extends through the side wall 12, and the first nut 26 is attached to the conduit 16 on the interior of the side wall 12. The second nut 28 is attached to the conduit 16 on the exterior of the side wall 12. The second end 20 of the conduit 16 is covered by the end 24 of the hose 22.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

Each and every patent, patent application and printed publication referred to above is incorporated herein by reference in toto to the fullest extent permitted as a matter of law.

This invention is susceptible to considerable variation in its practice. Therefore, the foregoing description is not intended to limit, and should not be construed as limiting, the invention to the particular exemplifications presented hereinabove.

1. A pot for frying or boiling, which comprises a pot having at least one side wall, the side wall defining a side opening at a level proximate to a top portion of the side wall, and a conduit sealably connected to the opening and extending outward form the side wall, which conduit has a first end defined by the opening and a second end defining an outlet, wherein an interior volume defined by the pot is in fluid communication with the conduit.

2. A pot as in claim 1 wherein a hose is sealably attached to the outlet of the conduit, and wherein the hose is in fluid communication with the conduit.

3. A pot as in claim 2 wherein the hose has an end which is threaded, and wherein the second end of the conduit is threaded.

4. An apparatus which comprises a nut capable of sealably attaching to a side opening which is defined by a side wall of a pot for frying or boiling, and a conduit having a first end for attachment to the nut and a second end defining an outlet, such that when the apparatus is assembled the conduit extends outward from the side wall of the pot, and such that an interior volume defined by the pot is capable of being in fluid communication with the nut and the conduit.

5. An apparatus as in claim 4 wherein a hose is sealably attached to the outlet of the conduit, and wherein the hose is in fluid communication with the conduit.

6. An apparatus as in claim 5 wherein the hose has an end which is threaded, and wherein the second end of the conduit is threaded.

7. An apparatus as in claim 4 wherein the side opening defined by the wall of the pot is threaded.

8. An apparatus as in claim 4 wherein the nut is threaded.

9. An apparatus as in claim 4 wherein the nut and the conduit are one piece.

10. An apparatus as in claim 4 wherein the apparatus has two nuts, a first nut for the interior of the side wall, and a second nut for the exterior of the side wall.

11. A method for frying a food item, the method comprising
(a) providing a frying pot, a side wall of which defines a side opening at a level proximate to a top portion of the side wall,
(b) connecting a conduit having a first end capable of sealably attaching to the frying pot and a second end defining an outlet to the side wall of the frying pot so as to place the conduit in fluid communication with an interior volume of the pot,
(c) placing a cooking oil into the interior volume of the frying pot,
(d) applying heat to the frying pot,
(e) placing the food item into the frying pot under conditions sufficient to cause the food item to fry, and
(f) draining through the side opening and conduit at least a portion of the cooking oil which rises to the level of the side opening after the food item is placed into the pot under conditions sufficient to cause the food item to fry.

12. A method according to claim 11 which further comprises sealably attaching a hose to the outlet of the conduit, wherein the hose is in fluid communication with the conduit.

13. A method according to claim 11 wherein the conduit is connected to the side wall of the frying pot via a nut.

14. A method according to claim 13 wherein the conduit and the nut are one piece.

15. A kit for adaptation of a frying pot for safer use, the kit comprising
(i) a nut for attachment to an opening which is defined by a side wall of a pot for frying or boiling,
(ii) a conduit having a first end capable of sealably attaching to the nut and a second end defining an outlet, and
(iii) optionally a hose sized and configured at one end for attachment to the second end of the conduit.

16. A kit as in claim 15 wherein the conduit and the nut are one piece.

17. A kit as in claim 15 wherein the hose is present.

18. A kit as in claim 17 wherein the hose has an end which is threaded, and wherein the second end of the conduit is threaded.
